(19) United States
(12) Patent Application Publication
(10) Pub. No.: US 2001/0034782 A1
(43) Pub. Date: Oct. 25, 2001

(54) Efficient web based proxy message method and apparatus for message queuing middleware resident on a server computer

(76) Inventor: Ian Kinkade, Madison, CT (US)

Correspondence Address: PERMAN & GREEN, 425 POST ROAD, FAIRFIELD, CT, 06430, US

(21) Appl. No.: 09/760,535

(22) Filed: Jan. 16, 2001

Related U.S. Application Data
(60) Provisional application No. 60/176,218, filed on Jan. 14, 2000.

(51) Int. Cl. G06F 15/16

(52) U.S. Cl. 709/219; 709/203

(57) ABSTRACT

A method for providing efficient bi-directional communications between a client computer and at least one server computer where the server computer hosts at least one message queuing middleware system. The method comprises the steps of providing a client computer code module resident on a client computer. The step of providing the client computer code further comprises the steps of providing at least one adapter code module resident on the client computer. The adapter code module receives a message from the client computer and associates the data message with the least one message queuing middleware system. The adapter code module transmits the associated data message to the at least one server computer. The server computer, holding in a quiescent state until a message is inbound, receives the associated data message. The next step provides a server computer code module resident on the at least one server computer which configures to select at least one messaging middleware protocol set based upon information contained within the received associated data message. The associated data message is translated to conform to the selected messaging middleware protocol set. The translated message is then sent to a messaging middleware system corresponding to the messaging middleware protocol and a status message is returned to the client computer.

### CROSS REFERENCE TO RELATED APPLICATIONS

Priority is herewith claimed under 35 U.S.C. §119(e) from copending Provisional Patent application No. 60/176,218, filed Jan. 14, 2000, entitled “An Efficient Web Based Proxy Message Method and Apparatus for Message Queuing Middleware Resident On a Server Computer”, by Ian Kinkade. The disclosure of this Provisional Patent Application is incorporated by reference herein in its entirety.

### BACKGROUND

Frequent corporate mergers and acquisitions occurring in today's marketplace, especially in competitive marketplaces such as the banking and telecommunications industries require geographically separated corporations to share each other's resources, and information such as computer data. Yet many, if not most, of the computer systems were not designed to inter-operate with other systems nor are the systems co-located. In other words, the information in one company's current applications located in country A may not be, and usually isn't, compatible with the other company's application located in country B. Thus, such mergers and acquisitions create new problems in the integration of incompatible and remote computer resources. One solution to these problems may be the exploitation of the world wide web. However, to apply this solution requires that the application be web enabled or able to transmit its data over the web to another application, also web enabled.

The problem of local application integration between different applications has been addressed by message queuing middleware service (MQMS). MQMS are a category of software products that provide store-and-forward message delivery, generally to a message queue. In this manner, a first MQMS translates data from one application, sends the data in the form of a message to a message queue, a second MQMS retrieves the message from the message queue, translates the data for use by a second application, and passes or pulls the data to the second application. In order for this activity to occur, there must be some modification of both the transmitting application and the receiving application for the applications to interface with the MQMSs. Thus, the implementation of these products can be, and usually is expensive. However, the alternative of scrapping the current systems and creating new ones is usually far more expensive. Consequently, the companies utilizing these products are not apt to readily change their underlying technology to accommodate system integration. Yet system integration of disparate and remote systems are critical to the existence of many corporations and organizations. Consider, for example, the complex military organizations and the underlying defense industry. System integration of leading technologies and legacy systems are often critical to the military to perform its mission; as well as to the defense contractor in order to be competitive in today's market place. The military and defense industries depend on MQMs to convey messages containing such data as radar, instrumentation, and confidential output messages from one application to another, from legacy applications to leading technology applications. Also consider companies seeking to exploit the expanding web-based economy. They also will require that their applications are web enabled. Companies such as these are seeking a fast, reliable and efficient means to conduct E-commerce. Many of these companies require Java centric bindings in order to make their applications web-enabled.

Typically, there are three classes of applications that use underlying Message Queuing Middleware Service (MQMS) products. Included in this group are those found in workflow management, data distribution and enterprise communications. Workflow management involves the monitoring and control of a unit of work as it progresses through a manufacturing or development process. Data distribution involves either the finding or sending of data between front-end clients and/or back-end databases. While enterprise communications involve the sharing and/or dissemination of information within an organization.

Within the context of computer networks and software programs messaging is defined as the deliberate transmission of data between two or more cooperating programs, which are part of a distributed system. In addition to the data contained within the message, there are parameters listed in the form of arguments that specify the programmatic behavior or properties of the message. For example, parameters such as the priority level of the message, the delivery mode (guaranteed or not), the message expiration time (duration of time that an undelivered message will be destroyed), reply-to-queue (whether the reply message should be sent to the senders queue or to some other queue), e.t.c., are examples of the programmatic data contained within the message's argument list. Ultimately, all the information required about the messages' address, method of delivery, return address of the sender, the message itself, plus any optional return certification will be specified in the message's argument list.

In general, a message is sent to or received from a message queue by an application. Each application has exactly one primary queue, which serves not only as the principal queue upon which it receives messages, but also as its attachment to a queuing engine. It may also have one or more secondary queues up to the limit imposed by the message transport.

Each queue can be named or unnamed. The distinction between the two is that, named queues are known throughout the enterprise and applications receiving messages from these queues know where to send a return message or, alternatively, may use the return address contained within the header of the message. An application that receives a message from an unnamed queue, can only reply to the sender using the queue address stored in the header of that message. Messages are sent in an envelope, i.e., a block of data, carrying information about the endian form of the sending machine, the reply address, the message size, priority and delivery mode.

Transmitted messages can have one or two priorities, normal or high. They can specify delivery modes (whether delivery is guaranteed or not and when the message will be deleted if it is undelivered). At the receiver side, a receiver may call for certain messages by applying receiver selection criteria to the received messages, e.g., high priority messages. The receiver may also issue a time out value to indicate whether the call is a poll (checking for existing messages) or a blocking read (waiting for a specific period of time). Messages are normally read from a queue destructively, but they may be subject to implicit or explicit acceptance. Messages that are implicitly accepted are removed from the queue by a subsequent read operation. Explicitly accepted ones require an explicit statement of acceptance by the application before they can be removed from the queue.

When a user application is created using a specific vendor's MQM product, the application must make calls to the vendors MQMS API in order to send or receive messages. Each MQMS API imposes specific programmatic behavior that must be written into the user application in order to utilize the MQMS API. In most cases, this imposes added and certainly undesirable, time and cost to implement a particular vendors product. As examples, return status values that are unique to one MQMS vendor or additional API calls that may be required by the another vendor's MQMS product must be coded into the user application in order to receive and transmit messages.

There are currently several vendors supplying MQMS. For example, IBM provides MQSeries, Microsoft provides Microsoft Message Queue (MSMQ), and BEA Systems, Inc. has Bea MessageQ, to name but a few. Moreover, while there are at least two Message-Oriented Middleware Associations, ostensibly to reduce the confusion among the MQMS products, there are currently no standards agreements to facilitate full interoperability between the different MQMS and the world wide web. This lack of standards leads to dependence on vendor proprietary approaches, thus inhibiting open system architecture.

### SUMMARY OF THE INVENTION

In accordance with one embodiment of the invention a method for providing efficient bi-directional communications between at least one client computer and at least one server computer is provided; the server computer hosts at least one message queuing middleware system. The method comprises the steps of providing at least one client computer code module resident on the client computer. Providing the client computer code module further comprises the step of installing at least one client code adapter on the client computer; the adapter is adaptable to remote message queuing service. The next step provides a second module for associating a data message with the least one message queuing middleware system; and transmitting the associated data message to the server computer. The associated data message is received on the at server computer wherein the next steps configure the server computer code module to select at least one messaging middleware protocol set based upon information contained within the received associated data message; translate the associated data message to conform to the selected messaging middleware protocol set; and returning a status message to the client computer.

In accordance with another embodiment of the invention a system for performing efficient web based proxy messaging for message queuing middleware is provided. The system comprises a client computer having at least one user application and at least one client software module having a data connection to the user application. The client software module also comprises a selector for associating a data message with at least one message queuing middleware system and a transmitter for transmitting the data message via a computer network. the system also comprises at least one server computer having an interface for communicating via the computer network. The server computer comprises a translator and at least one message queuing middleware system connectable to the translator.

Another embodiment of the invention is directed towards a method for providing an efficient proxy message method for message queuing middleware. The message queuing middleware is hosted on at least one server computer, the server computer having access to at least one client computer. The method comprises the steps of receiving at least one function call from the client computer and translating the at least one function call to at least one receiver format. The next step transmits the translated function call to the server where the server executes the translated function call.

The invention is also directed to a computer readable medium embodying program code embodying a program of instructions executable by the machine to perform method steps for providing efficient bi-directional communications between a client computer and at least one server computer. The method comprises the step of providing at least one client computer code module resident on the client computer. The step of providing the client computer code further comprises the steps of providing at least one client code module on the client computer, wherein the client code module comprises remote message queuing service and an associator for associating a data message with the least one message queuing middleware system. The next step transmits the associated data message to the at least one server computer. The associated data message is received on the at least one server computer the server configures a server computer code module to select at least one messaging middleware protocol set based upon information contained within the received associated data message. The data message is translated to conform to the selected messaging middleware protocol set and sent to the appropriate messaging middleware system while a status message is returned to the client computer.

### BRIEF DESCRIPTION OF THE DRAWINGS

The foregoing aspects and other features of the present invention are explained in the following description, taken in connection with the accompanying drawings, wherein:

FIG. 1 is a block diagram of a system incorporating features of the present invention;

FIG. 2 is a method flow chart for translating and transporting a function call using the system shown in FIG. l;

FIG. 3 is a detailed method flow chart of translating and transmitting a data message using the system shown in FIG. 1; and

FIG. 4 is a method flow chart of one embodiment of the invention showing the steps for creating a unique child process in response to a message request using the system shown in FIG. l.

### DETAILED DESCRIPTION OF THE PREFERRED EMBODIMENT

Although the present invention will be described with reference to the single embodiment shown in the drawings, it should be understood that the present invention can be embodied in many alternate forms of embodiments.

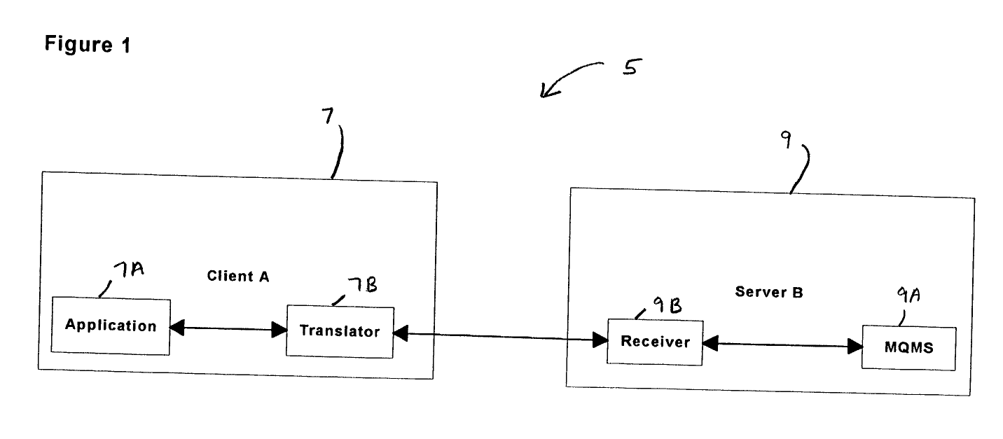

The system 5 incorporating features of the present invention is for enabling communications between disparate messaging middleware environments. As seen in FIG. 1 the system 5 generally comprises a client computer 7 and a server computer 9. The client computer 7 and the server computer 9 are adapted to translate, transmit, and receive a message format recognizable by the client computer 7 or the server computer 9. Message formats may be in any suitable form recognizable by both the client computer 7 and the server computer 9. Message formats may also be translated to a suitable form as described in U.S. provisional patent titled “Uniform Applications Programming Interface for Messaging Middleware” application Ser. No. 60/176,337, filed Jan. 14, 2000 and patent application Attorney Docket number 735-009097US(PAR) filed herewith. The entire contents of said provisional patent application and said patent application are herein incorporated by reference. As shown, the application 7A is hosted on client computer 7 while the Message Queuing Middleware Service (MQMS) 9A is hosted on sever computer 9. By adding the functionality of translator 7B and receiver 9B , only one copy of MQMS 9A on server computers 9 is needed. Thus solving the problem of having to host another MQMS system on client computer B. It can be readily appreciated that there may be more than one MQMS 9B residing on server computer 9 and that more than one client computer 7 may be connected to the server computer 9 through a network such as an intranet or internet.

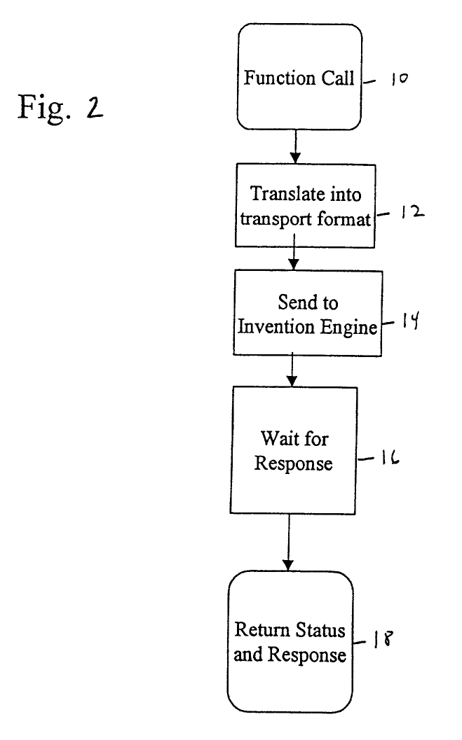

Referring now to FIG. 2 there is shown one method incorporating features of the present invention. In general, the client/server application sends or receives messages by executing function calls to the MQMS product's Runtime Library (RTL). Function calls are routines commonly known as Application Programming Interface(s) or API(s). They serve as the instruction set for directing messages and providing guidelines and controls for the passing or the pulling of messages through their respective client/server application environment to their ultimate destination. This process is illustrated in FIG. 2, where the user application makes a function call 10 and the function call is translated 12 into a transport format. The transport format is transmitted 14 to the Engine which executes the function. The Engine waits for a response 16 and returns 18 a status and the response to the initiating entity.

Features of the invention provide at least one application with local queuing services from a remote Message Queuing Middleware Service (MQMS) in a Client/Server architecture. The features comprise two components: a set of libraries and/or classes on the Client side and an Engine on the remote MQMS Server side. The libraries support a ‘C’ language implementation and the classes support a Java implementation. The users application is compiled and linked with the libraries or classes to provide the remote queuing service.

The first call issued by the client application is an initiation request defining the configuration file, a feature of the invention determines the hostname and endpoint of the Engine. The next call defines the MQMS vendor service/API translation that the Engine should use and the message queue identification of the initial queue that the Engine should use for its attachment to the MQMS. Initially, this call causes the client application to make a connection to the remote Engine. Upon receipt of the message, the Engine unpacks the contents of the message and determines which MQMS is the ultimate receiver. The Engine attaches itself to the specified primary message queue on the MQMS Server and executes the call using any unpacked arguments from the message. The message queues associated with the MQMS coordinate the flow of messages in conjunction with the MQMS that is being utilized by the receiving application on the Server. After the call is executed, the Engine will pack the return status message and send it back to the sending application to complete the process.

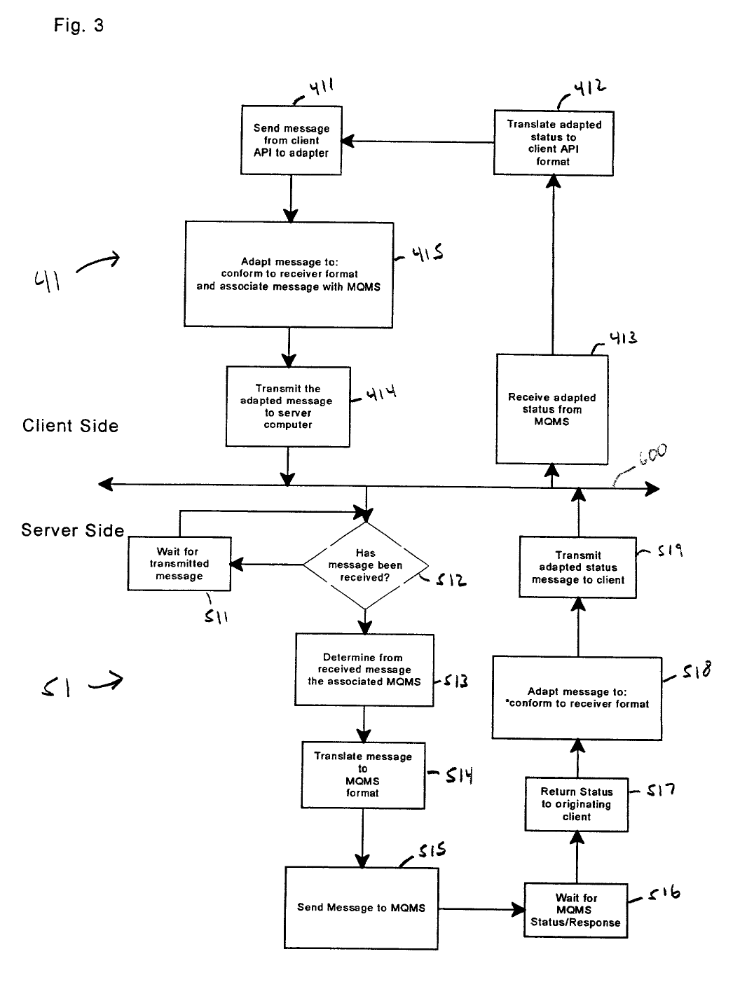

Referring now to FIG. 3 there is shown a detailed method flow chart of translating and transmitting a data message using the system shown in FIG. 1. On the client side 41 a client application initiates message data transfer requests by sending 411 function calls or messages to the appropriate classes or libraries and utilizing the Application Programming Interface (API) protocol. The libraries or classes convert 415 each application's call and argument list into a receiver message format and transmit 414 over a TCP/IP link 600, or any suitable link, to a predefined endpoint or server 51. The message contains all of the information that is necessary for the server to execute the call locally to a MQMS. The server 51 determines 512 if a message has been received and determines 513 from the received message the MQMS that is associated with the message. If the server 51 determines 512 that a message has not been received then the server 51 waits 511 until a message is received. Once the message is received and decoded the server translates 514 the function call into the appropriate MQMS API call and executes the call(s) on behalf of the client application by sending 515 the message to the MQMS. The server waits 516 for a response and returns 517 the response or status to the originating client or another identified receiver by adapting the message 518 to the client receiver format and transmitting 519 the adapted response over the network 600. It is possible that more than one MQMS API call will be required to complete one API call. The client 41 receives 413 the adapted status from the MQMS and translates 412 the adapted status to the client API format.

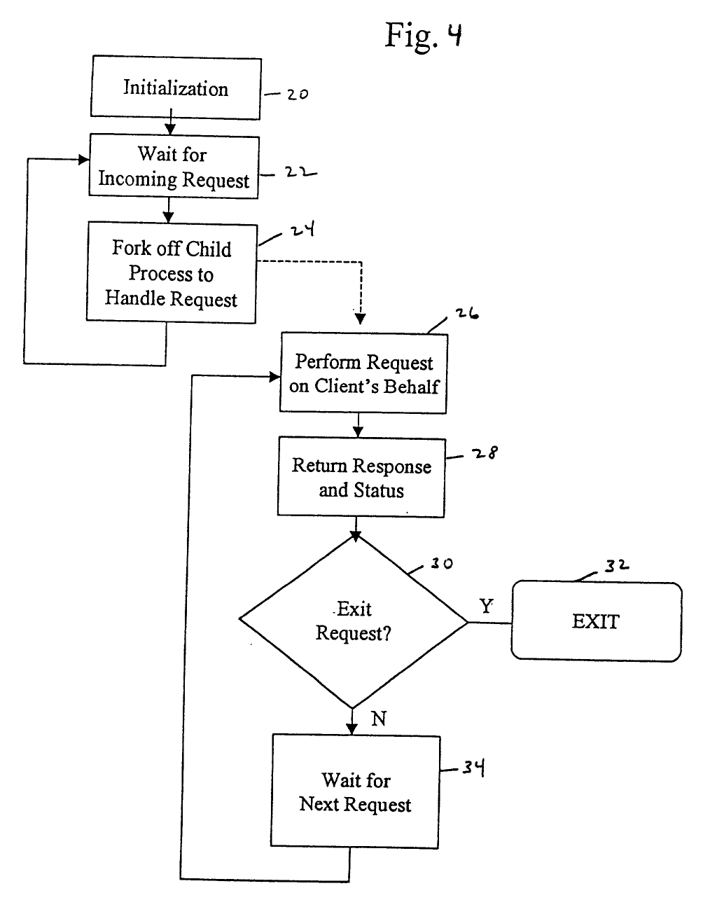

The first instance of the server side Engine is a master instance and will listen on a specified Endpoint (TCP/IP socket address for example) for an incoming connection from a client application. The Engine utilizes an embedded universal translator to provide MQMS independence and a uniform programmatic behavior. When a client application initiates a call for a queue, it sends a request to the Engine Endpoint. The Engine, upon receipt of the request will create (fork on Unix and thread on WindowsNT) a process instance of the Engine to service the incoming request. Since the Engine instances are under the control of the local Operating System scheduler and specific instances for each remote client are created, the Engine can provide efficient utilization of the Central Processing Unit (CPU) and a high level response to the clients. When the Engine is waiting on an incoming request from a client, it is in a sleep state, and does not consume system resources such as CPU cycles. Referring now to FIG. 4 there is shown a method flow chart illustrating the steps for creating the fork or thread process responding to an incoming message. The process begins when the method is initialized 20 by a client application making a function call. A feature of the invention converts the function call into a receiver function call by using an internal matrix to map the call to the standard that matches the selected requirements.(For non-traditional APIs, the internal matrix maps the function to the most logical match; making its best effort to map it to the closest function available.) Another feature of the invention waits 22 for an incoming message request, and forks 24 or creates a thread within the process, i.e., creates an instance of the invention engine to accomplish the request. The former instance of the Engine then becomes the Master Engine, and the latter instance is referred to as simply the Engine. The later instance of the Engine effectively provides the remote client with access to one or more MQMS message queues. This latter instance can enable the remote client to effectively attach to a primary message queue and as many secondary message queues as required to handle the messages traffic. All message queues and messages reside on the MQMS Server side of the client/server architecture until the client requests the Engine to read a queue or send messages to a queue. After a request is received, the Engine performs the request on the Client's behalf 26 and sends 28 a return status response back to the sending application. The Engine then either waits 34 for the next request or exit 32.

Through out the entire procedure, a feature of the invention enables all components to hold in a wait status until they are called upon to accomplish their next function. In this manner, computer resources are efficiently utilized. Additionally, the libraries and Java classes contain the data and instructions to convert API function calls into a single message format thereby providing a uniform and single behavioral connection to a remote MQMS.

The advantages of the invention permit a user to overcome the problems noted in the prior art by exploiting the connectivity of the world wide web. Namely, a user may advantageously use the invention to connect multiple disparate systems with various middleware products that are geographically separated. In addition, it is readily appreciated that another advantage of the invention is that the vendor's MQM systems only need reside on the server computer and are not needed on the client computer; thus reducing the complexity and client side resource consumption.

One form of the current invention is implemented as IQJump™ available from: Information Design, Inc., 145 Durham Road, Suite 11, Madison, Conn. 06443.

What is claimed is:

1. A method for providing efficient bi-directional communications between a client computer and at least one server computer, the at least one server computer hosting at least one message queuing middleware system, the method comprising the steps of:
providing at least one client computer code module resident on the client computer, wherein the step of providing the at least one client computer code module further comprises the steps of:
providing at least one client code adapter on the client computer, wherein the client code adapter comprises:
providing a first module adaptable to remote message queuing service;
providing a second module for associating a data message with the least one message queuing middleware system;
transmitting the associated data message to the at least one server computer;
receiving the associated data message on the at least one server computer;
providing a server computer code module resident on the at least one server computer, wherein the step of providing the server computer code module further comprises the steps of:
configuring the server computer code module to select at least one messaging middleware protocol set based upon information contained within the received associated data message;
translating the associated data message to conform to the selected messaging middleware protocol set; and
returning a status message to the client computer.

2. A method as in claim 1 wherein the step of transmitting the associated data message to the at least one server further comprises the step of transmitting the associated data message according to a communication protocol.

3. A method as in claim 2 wherein the step of transmitting the associated data message according to the communication protocol further comprises the step of transmitting the associated data message according to the Transmission Control Protocol/Internet Protocol (TCP/IP).

4. A method as in claim 2 wherein the step of the step of transmitting the associated data message according to the communication protocol further comprises the step of transmitting the associated data message according to a wireless communication protocol.

5. A method as in claim 1 wherein the step of providing at least one client computer code module resident on the client computer further comprises the step of providing the at least one client computer code module to be compatible with JAVA language programming code.

6. A method as in claim 1 wherein the step of configuring the server computer code module to select at least one messaging middleware protocol set further comprises the step of:
selecting the at least one messaging middleware protocol set from the group of messaging middleware sets consisting of a first messaging protocol, a second messaging protocol, and a third messaging protocol.

7. A system for performing efficient web based proxy messaging for message queuing middleware, the system comprising:
a client computer, wherein the client computer comprises:
at least one user application;
at least one client software module, wherein the at least one client software module comprises:
a data connection to the at least one user application;
a selector for associating a data message with at least one message queuing middleware system;
a transmitter for transmitting the data message via a computer network;
at least one server computer having an interface for communicating via the computer network, the server computer comprising:
a translator; and
at least one message queuing middleware system connectable to the translator.

8. A system as in claim 7 wherein at least one client software module comprises:
at least one library, wherein the at least one library comprise software code adaptable to compiling.

9. A system as in claim 8 wherein the software code is C language code.

10. A system as in claim 7 wherein the at least one client software module comprises:
at least one class, wherein the at least one class is adaptable to interfacing with JAVA programming code.

11. A system as in claim 7 wherein the transmitter further comprises the transmitter adaptable to transmitting the associated data message according to a communication protocol.

12. A system as in claim 11 wherein the transmitter for transmitting the associated data message according to a communication protocol further comprises the transmitter adaptable to transmitting the associated data message according to the Transmission Control Protocol/Internet Protocol (TCP/IP).

13. A system as in claim 11 wherein the transmitter for transmitting the associated data message according to a communication protocol further comprises the transmitter adaptable for transmitting the associated data message according to a wireless protocol.

14. A system as in claim 7 wherein the translator further comprises the translator adaptable for selecting at least one messaging middleware protocol set.

15. A system as in claim 7 wherein the selector for selecting the at least one messaging middleware protocol set further comprises the selector adaptable for selecting the at least one messaging middleware protocol set from the group of messaging middleware sets consisting of a first messaging protocol, a second messaging protocol, and a third messaging protocol.

16. A method for providing an efficient proxy message method for message queuing middleware hosted on at least one server computer having access to at least one client computer, the method comprising the steps of:
receiving at least one function call from the client computer;
translating the at least one function call to at least one receiver format;
transmitting the at least one function call translated into at least one receiver format to the at least one server; and
executing the at least one function call translated into at least one receiver format.

17. A method as in claim 16 wherein the step of receiving the at least one function call from the client computer further comprises the step of applying the function call to a client software module.

18. A method as in claim 16 wherein the step of translating the at least one function call to at least one receiver format further comprises the step of translating the function call into a predetermined message queuing protocol.

19. A method as in claim 16 wherein the step of transmitting the at least one function call translated into at least one receiver format further comprises the step of transmitting via a communications protocol.

20. a method as in claim 16 wherein the step of executing the at least one function call translated into at least one receiver format further comprises the step of returning a message resulting from the executed function call.

21. At least one program storage device readable by a machine, tangibly embodying a program of instructions executable by the machine to perform method steps for providing efficient bi-directional communications between a client computer and at least one server computer, the method comprising the steps of:
providing at least one client computer code module resident on the client computer, wherein the step of providing the at least one client computer code further comprises the steps of:
providing at least one library resident on the client computer, wherein the library comprises:
means for remote message queuing service;
means for associating a data message with the least one message queuing middleware system;
transmitting the associated data message to the at least one server computer;
receiving the associated data message on the at least one server computer;
providing a server computer code module resident on the at least one server computer, wherein the step of providing the server computer code module further comprises the steps of:
configuring the server computer code module to select at least one messaging middleware protocol set based upon information contained within the received associated data message;
translating the associated data message to conform to the selected messaging middleware protocol set; and
returning a status message to the client computer.
